(19) United States
(12) Patent Application Publication
(10) Pub. No.: US 2010/0313016 A1
(43) Pub. Date: Dec. 9, 2010

(54) Transport Pipeline Decryption for Content-Scanning Agents

(75) Inventors: Hao Zhang, Sammamish, WA (US); Danny Tin-Van Chow, Seattle, WA (US); Ayse Yesim Koman, Seattle, WA (US); Frank D. Byrum, Seattle, WA (US); Mayank Mehta, Redmond, WA (US); Chandresh K. Jain, Sammamish, WA (US); Victor Boctor, Redmond, VA (US); Charlie R. Chung, Tacoma, WA (US); Tejas D. Patel, Seattle, WA (US); Yuhui Zhong, Sammamish, WA (US); Amit K. Fulay, Kirkland, WA (US); Gregory Kostal, Kirkland, WA (US); Pankaj M. Kamat, Kirkland, WA (US); Vladimir Yarmolenko, Duvall, WA (US); Krassimir E. Karamfilov, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/478,608

(22) Filed: Jun. 4, 2009

(51) Int. Cl. H04L 9/32; H04L 9/00

(52) U.S. Cl. 713/168; 726/4; 713/150

(57) ABSTRACT

Transport pipeline decryption may be provided. Consistent with embodiments of the invention, a protected message may be received and decrypted. The decrypted message may be provided to pipeline agents, such as anti-virus, anti-spam, journaling, and/or policy enforcement agents. The message may then be re-encrypted and delivered.

### RELATED APPLICATION(S)

Related U.S. patent application Ser. No. 12/476,049, filed on Jun. 1, 2009 herewith having attorney docket number 14917.1291US01/MS327109.01 and entitled “Business to Business Secure Mail” assigned to the assignee of the present application, is hereby incorporated by reference.

Related U.S. patent application Ser. No. ______, filed on Jun. 5, 2009 herewith having attorney docket number 14917.1296US01/MS327108.01 and entitled “Persistent Document Protection” assigned to the assignee of the present application, is hereby incorporated by reference.

### BACKGROUND

Transport pipeline decryption is a process for allowing the scanning of content in encrypted messages. In some situations, organizations may wish to scan incoming messages in accordance with organization policies. For example, a company may wish to employ agents such as anti-virus and/or anti-spam scanners, but those agents may not be able to decrypt the content. Thus, the conventional strategy is to either reject encrypted messages out of hand or bypass the agents. This often causes problems because the conventional strategy may result in valuable messages being lost or harmful messages being allowed in. For example, a company may receive a flood of e-mails containing viruses that cannot be detected until the message is opened by a user, potentially allowing the virus to harm the organization's computers.

### SUMMARY

Transport pipeline decryption of protected messages may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Transport pipeline decryption may be provided. Consistent with embodiments of the invention, a protected message may be received and decrypted. The decrypted message may be provided to pipeline agents, such as anti-virus, anti-spam, journaling, and/or policy enforcement agents. The message may then be re-encrypted and delivered.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing transport pipeline decryption; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Transport pipeline decryption may be provided. Consistent with embodiments of the present invention, an organization may wish to scan the content of incoming, internal, and/or outgoing messages, such as for anti-virus, anti-spam, journaling, or policy enforcement. For example, a message sent from one user to another user within the same organization may be accessed by a pipeline agent operative to insert a confidentiality notice. Encrypted messages may need to be decrypted so that the clear text of the message may be provided to pipeline agents for scanning prior to re-encryption and delivery.

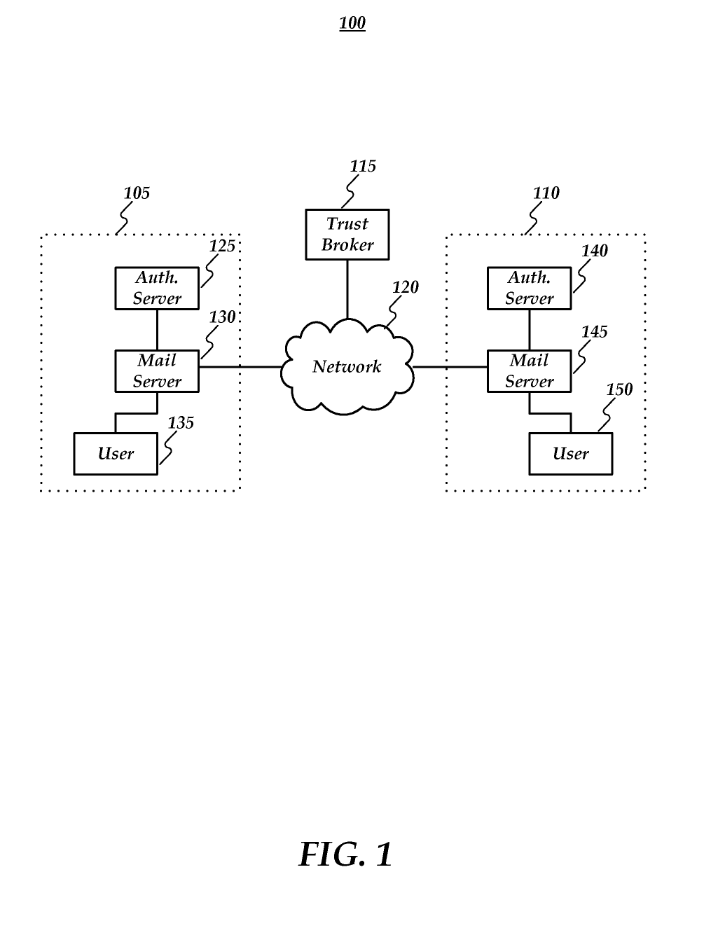

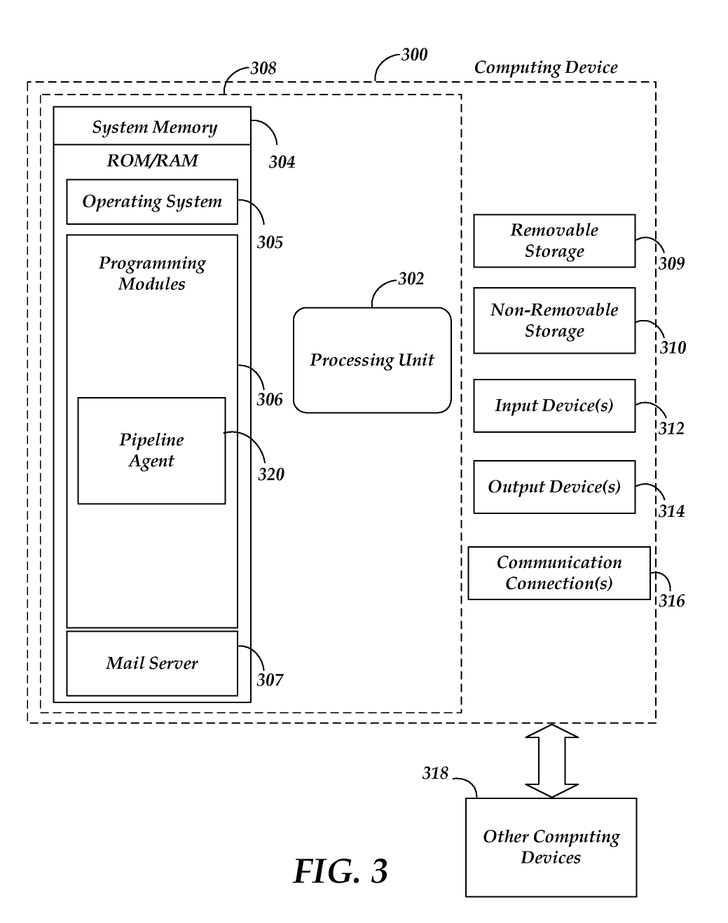

FIG. 1 is a block diagram of an operating environment 100 that may utilize transport pipeline decryption. Operating environment 100 may comprise a first organization 105, a second organization 110, and a trust broker 115 that may communicate via a network 120. First organization 105 may comprise a first authorization server 125, a first mail server 130, and a first user 135. Second organization 110 may comprise a second authorization server 140, a second mail server 145, and a second user 150. For example, trust broker 115 may comprise a Microsoft® Windows Live® federation server, as produced by Microsoft® Corporation of Redmond, Wash. Authorization servers 125 and 140 may comprise a Windows® Server 2008 server, as produced by Microsoft® Corporation of Redmond, Wash. Mail servers 130 and 145 may each comprise an Exchange® server, also produced by Microsoft® Corporation of Redmond, Wash. First user 135 may comprise a computing device such as computing device 300, described below with respect to FIG. 3, used by a sender of a message. Second user 150 may also comprise a computing device used by a recipient of the message. Network 120 may comprise a public network, such as the Internet, a cellular data network, a VPN, or other communication medium. Although examples are provided with respect to an e-mail message, the methods described may be applied to any protected electronic document that may be shared among different users.

Pipeline decryption may comprise decryption of the protected message on behalf of an organization and/or a recipient other than the final recipient of the message. For example, an organization may receive messages sent by other organizations. Policies of the receiving organization may comprise instructions that incoming messages should be scanned by pipeline agents, such as an anti-virus scanning agent or a spam filtering agent. Other agents may include an archiving and/or journaling agent operative to save copies of incoming messages.

Encrypted messages may pose a problem for these pipeline agents, for the pipeline agents may need access to the clear text of the message in order to function. Thus the organization may need to designate a server, such as mail server 145, as being responsible for decrypting the message and providing access to the clear text of the message for the pipeline agents. Consistent with embodiments of the invention, an administrative user account may be used to request the decryption key on behalf of the receiving organization.

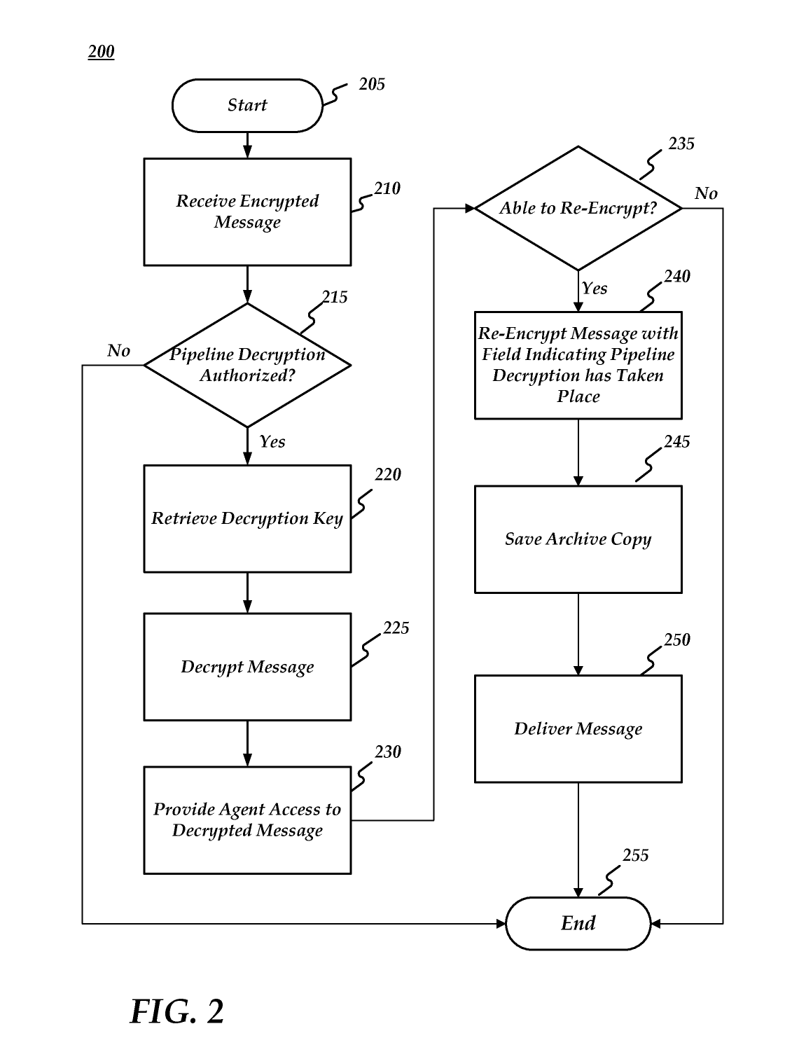

FIG. 2 is a flow chart setting forth the general stages involved in a method 200 consistent with an embodiment of the invention for providing transport pipeline decryption. Method 200 may be implemented using computing device 300 as described in more detail below with respect to FIG. 3. Ways to implement the stages of method 200 will be described in greater detail below. Method 200 may begin at starting block 205 and proceed to stage 210 where computing device 300 may receive a protected message. For example, second mail server 145 may receive a message created and/or sent by first user 135. Second mail server 145 may determine that the message is protected against an authorization server associated with another organization, such as first authorization server 125 associated with first organization 105.

From stage 210, where computing device 300 received the protected message, method 200 may advance to stage 215 where computing device 300 may determine whether computing device 300 is authorized to perform pipeline decryption. For example, second mail server 145 may determine whether the protected message comprises a property field authorizing pipeline decryption. The property field may be set by a sender, such as first user 135, or as a policy of a sending organization, such as first organization 105. The property field may be signed to prevent spoofing of the field, and the signature may need to be verified prior to allowing pipeline decryption. The authorization server receiving the request for a decryption license may be operative to validate the signature before issuing the license. The property field may comprise a list of organizations authorized to perform pipeline decryption. Consistent with embodiments of the invention, the property field may comprise a Boolean (true/false) property authorizing or denying pipeline decryption by any recipient. If computing device 300 is not authorized to perform pipeline decryption, method 200 may end at stage 255 and the protected message may be delivered to a recipient and/or discarded by the receiving organization without being decrypted.

If computing device 300 determines that the receiving organization is authorized to perform pipeline decryption in stage 215, method 200 may continue to stage 220 where computing device 300 may retrieve a decryption key for the protected message. For example, second mail server 145 may receive a security token from trust broker 115 that verifies the identity of the receiving organization. The security token may then be sent to, for example, first authorization server 125 associated with first organization 105 where first organization 105 comprises a sending organization. First authorization server 125 may return a decryption key for the protected message authorizing and/or enabling second mail server 145 to decrypt the message.

From stage 220, method 200 may proceed to stage 225 where computing device 300 may decrypt the message. For example, second mail server 145 may use the received decryption key to produce a decrypted, clear text version of the protected message. Consistent with embodiments of the invention, the decryption key may be stored along with the decrypted message and/or the encrypted message. This may allow the efficient re-encryption of the message at a later time using the same key.

From stage 225, where computing device 300 decrypted the protected message, method 200 may advance to stage 230 where computing device 300 may provide access to the decrypted message and/or the encrypted message to a pipeline agent. Each of a plurality of pipeline agents may be assigned a priority number that may be used to determine an order in which the pipeline agents may access the message. For example, an anti-virus agent may scan the message for viruses, then a spam-filtering agent may determine whether the message content indicates that the message comprises an unwanted message. A journaling agent may save a copy of the decrypted and/or the encrypted message to an archive.

Consistent with embodiments of the invention, stage 225 may be performed by a server associated with a sending organization. For example, first mail server 130 may decrypt an outgoing protected message, provide access to a policy agent operable to insert a standard confidentiality disclaimer in the message, and re-encrypt the message before sending the message to its recipient(s).

Further consistent with embodiments of the invention, pipeline agents may register with computing device 300. The registration may comprise a requested priority and an indication whether the agent needs access to the decrypted message, the encrypted message, and/or both. For example, a journaling agent may register with a low priority in order to only archive messages identified as clean by an anti-virus agent.

From stage 230, method 200 may advance to stage 235 where computing device 300 may determine whether it is able to re-encrypt the decrypted message. For example, the decryption key may be associated with a permission license that only authorizes read access to a message. If computing device 300 is determined to be unable to re-encrypt the message at stage 235, method 200 may end at stage 255 and the message may be discarded and may not be delivered. Consistent with embodiments of the invention, a non-delivery notification may be sent to the message's sender.

If, at stage 235, computing device 300 determines that the decrypted message may be re-encrypted, method 200 may advance to stage 240 where computing device 300 may re-encrypt the decrypted message. For example, second mail server 145 may use the decryption key saved with the decrypted message to re-encrypt the message. Consistent with embodiments of the invention, computing device 300 may retrieve a new copy of the decryption key from an authorization server.

Further consistent with embodiments of the invention, computing device 300 may stamp the re-encrypted message with a property field indicating that the message has already been processed by at least one pipeline agent associated with the organization. For example, second mail server 145 may comprise a central mail server of second organization 110. After the processing of method 200, the re-encrypted message may be sent to a relay mail server (not shown) associated with a regional office of the organization. Messages received by the relay mail server may be subject to the same content-scanning policies as messages received by second mail server 145. The stamped property field may inform the relay mail server which pipeline agents have already been provided access to the message so that the relay mail server may bypass the decryption/re-encryption process. Consistent with embodiments of the invention, the property field may allow the relay mail server to decrypt the message and provide access to the message contents to a different and/or redundant pipeline agent associated with the relay mail server. For example, the relay mail server may decrypt the message and provide access to a journaling agent to save an archive copy without re-scanning the message by an anti-virus agent.

From stage 240, method 200 may advance to stage 245 where computing device 300 may save an archive copy of the protected message. For example, if a pipeline agent modified the text of the decrypted message, computing device 300 may save a copy of the original, protected message, the original, decrypted message, the modified, decrypted message, and/or the modified, re-encrypted message.

From stage 245, method 200 may advance to stage 250 where computing device 300 may deliver the re-encrypted message to a receiving user. For example, second mail server 145 may deliver the re-encrypted message to an e-mail inbox associated with second user 150. After delivering the message at stage 250, method 200 may then end at stage 255.

An embodiment consistent with the invention may comprise a system for providing pipeline decryption. The system may comprise a memory storage and a processing unit coupled to the memory storage. The processing unit may be operative to receive an encrypted message, determine, by a server associated with an organization receiving the message, whether pipeline decryption is authorized for the message, decrypt the message if authorized, and provide access to the decrypted message to a pipeline agent. Attempts to decrypt the message, whether or not authorized, may be recorded and reported to a sender of the message.

Consistent with embodiments of the invention, attempts to be recorded wherein the receiving organization may inform an authorization server associated with a sending organization upon receipt of an encrypted message from the sending organization and/or may request a decryption key for the encryption message. The processing unit may determine whether a sending user and/or organization configured a permission setting of the encrypted message authorizing pipeline decryption by the receiving organization.

The processing unit may be further operative to determine whether the message may be re-encrypted prior to delivering the message to a recipient, and may discard the message if re-encryption is not possible. Consistent with embodiments of the invention, read-only pipeline decryption may be provided. For example, the encrypted message may be saved and delivered to at least one recipient as originally received. This may result in changes made to the decrypted message by a pipeline agent being effectively discarded and may guarantee that the protected message is not altered. Pipeline decryption may be performed by either and/or both of the sending organization and the receiving organization.

Another embodiment consistent with the invention may comprise a system for providing transport pipeline decryption. The system may comprise a memory storage and a processing unit coupled to the memory storage. The processing unit may be operative to receive a protected message, decrypt the protected message, provide access to the protected message to at least one message agent, re-encrypt the decrypted message, and deliver the re-encrypted message. The processing unit may be further operative to request a decryption key for the protected message from an authorization server, save the decryption key with the decrypted message, and re-encrypt the message with the same key. The message agent may be operative to register with the processing unit for access to the message content, scan, and/or alter the content of the message. The processing unit may be further operative to stamp the re-encrypted message with a property, such as an X-header, for example, indicating that the message has been provided to at least one messaging agent. The processing unit may also be operative to scan a received message and determine if the stamped property indicates that the message has already been provided to appropriate messaging agents associated with the organization. If the message has already been scanned, the processing unit may be operative to bypass the decryption and content scanning.

Yet another embodiment consistent with the invention may comprise a system for providing secure mail between organizations. The system may comprise a memory storage and a processing unit coupled to the memory storage. The processing unit may be operative to receive an encrypted message, determine whether the protected message comprises at least one property authorizing pipeline decryption prior to delivery to a receiving user, and, in response to determining that the protected message comprises at least one property authorizing pipeline decryption prior to delivery to a receiving user, retrieve a decryption key associated with the encrypted message from an authorization server associated with a sender of the encrypted message, decrypt the encrypted message, wherein the system is associated with at least one of the following: a sending organization and a receiving organization, save the decryption key with the decrypted message, provide read access and write access to the encrypted message and the decrypted message to at least one pipeline agent, and determine whether the system is operable to re-encrypt the decrypted message. In response to determining that the server is operable to re-encrypt the decrypted message, the processing unit may be further operative to re-encrypt the message with the saved decryption key, send the re-encrypted message to at least one recipient, save an archive copy of the decrypted message and the encrypted message, and add at least one property field to the re-encrypted message, wherein the at least one property field identifies the re-encrypted message as having been provided to the at least one pipeline agent by the server.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise an operating environment for system 100 as described above. System 100 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include an encryption component 307. Operating system 305, for example, may be suitable for controlling computing device 300's operation. In one embodiment, programming modules 306 may include a client e-mail application 320. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. client e-mail application 320) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing pipeline decryption, the method comprising:
receiving an encrypted message;
decrypting the encrypted message by a server; and
providing access to the decrypted message to at least one pipeline agent.

2. The method of claim 1, further comprising:
determining whether the server is operable to re-encrypt the decrypted message; and
in response to determining that the server is operable to re-encrypt the decrypted message, re-encrypting the message.

3. The method of claim 2, further comprising:
in response to determining that the server is not operable to re-encrypt the decrypted message, discarding the message.

4. The method of claim 3, further comprising:
in response to determining that the server is not operable to re-encrypt the decrypted message, notifying a sender of the message that the message was not delivered.

5. The method of claim 1, further comprising:
prior to decrypting the encrypted message, determining whether the receiving organization is authorized to decrypt the message for the at least one pipeline agent.

6. The method of claim 3, wherein determining whether the receiving organization is authorized to decrypt the message for the at least one pipeline agent comprises determining whether a permission setting associated with the encrypted message authorizes an organization associated with the server to decrypt the message.

7. The method of claim 6, further comprising determining, by a sender of the message, whether a receiving organization not authorized to decrypt the encrypted message has attempted to decrypt the encrypted message.

8. The method of claim 1, wherein the server is associated with a sender of the encrypted message.

9. The method of claim 1, wherein the server is associated with a recipient of the encrypted message.

10. The method of claim 1, further comprising retrieving a decryption key associated with the protected message from an authorization server associated with a sender of the message.

11. The method of claim 10, further comprising:
saving the decryption key associated with the protected message with the decrypted message; and re-encrypting the decrypted message using the saved decryption key.

12. The method of claim 1, further comprising:
saving the encrypted message with the decrypted message; and
delivering the encrypted message as originally received to at least one recipient.

13. The method of claim 1, further comprising storing an archive version of the encrypted message and the decrypted message.

14. A computer-readable medium which stores a set of instructions which when executed performs a method for providing transport pipeline decryption, the method executed by the set of instructions comprising:
receiving a protected message;
decrypting the protected message;
providing access to the protected message to at least one message agent;
re-encrypting the decrypted message; and
delivering the re-encrypted message.

15. The computer-readable medium of claim 14, further comprising stamping the re-encrypted message with at least one property indicating that the message has been provided to the at least one message agent.

16. The computer-readable medium of claim 14, wherein the at least one message agent comprises at least one of the following: an anti-virus agent, a journaling agent, a policy agent, and a spam filter agent.

17. The computer-readable medium of claim 14, further comprising providing write access to the decrypted message to the at least one message agent.

18. The computer-readable medium of claim 14, further comprising receiving a registration from the at least one message agent.

19. The computer-readable medium of claim 14, further comprising:
determining whether the protected message comprises at least one property authorizing pipeline decryption prior to delivery to a receiving user; and
in response to determining that the protected message does not comprise the at least one property authorizing pipeline decryption prior to delivery to a receiving user, delivering the protected message to the receiving user without decrypting the protected message.

20. A system for providing transport pipeline decryption, the system comprising:
a memory storage; and
a processing unit coupled to the memory storage, wherein the processing unit is operative to:
receive an encrypted message,
determine whether the protected message comprises at least one property authorizing pipeline decryption prior to delivery to a receiving user,
in response to determining that the protected message comprises at least one property authorizing pipeline decryption prior to delivery to a receiving user:
retrieve a decryption key associated with the encrypted message from an authorization server associated with a sender of the encrypted message,
decrypt the encrypted message, wherein the system is associated with at least one of the following: a sending organization and a receiving organization,
save the decryption key with the decrypted message,
provide read access and write access to the encrypted message and the decrypted message to at least one pipeline agent, wherein the at least one pipeline agent comprises at least one of the following: an anti-virus agent, a journaling agent, a policy agent, and a spam filter agent;
determine whether the system is operable to re-encrypt the decrypted message, and
in response to determining that the server is operable to re-encrypt the decrypted message:
re-encrypt the message with the saved decryption key,
send the re-encrypted message to at least one recipient,
save an archive copy of the decrypted message and the encrypted message, and
add at least one property field to the re-encrypted message, wherein the at least one property field identifies the re-encrypted message as having been provided to the at least one pipeline agent by the server.
